(19) United States
(12) Patent Application Publication
(10) Pub. No.: US 2015/0288715 A1
(43) Pub. Date: Oct. 8, 2015

(54) Systems And Methods For Protecting Websites From Botnet Attacks

(71) Applicant: Samuel Hotchkiss, Alburquerque, NM (US)

(72) Inventor: Samuel Hotchkiss, Alburquerque, NM (US)

(73) Assignee: Automattic, Inc., San Francisco, CA (US)

(21) Appl. No.: 14/677,046

(22) Filed: Apr. 2, 2015

Related U.S. Application Data
(60) Provisional application No. 61/974,486, filed on Apr. 3, 2014.

(51) Int. Cl. H04L 29/06

(52) U.S. Cl. CPC H04L 63/1441; H04L 63/0876; H04L 63/101; H04L 63/1458

(57) ABSTRACT

A computer-implemented method for preventing an unauthorized login attempt includes the steps of: (i) receiving, at a central server in communication with a plurality of servers in a distributed computing network, a first communication comprising a security key and an IP address associated with an entity attempting to login to a website hosted by a server; (ii) comparing, by the central server, the received security key to a stored list of security keys; (iii) authenticating the first communication if the received security key matches one of the stored security keys; (iv) comparing, by the central server, the received IP address to blacklisted IP addresses; (v) determining whether the received IP address is one of the blacklisted IP addresses; and (vi) providing, to the server, an indication of whether the IP address is one of the blacklisted IP addresses.

### CROSS-REFERENCE TO RELATED APPLICATION

This application claims priority to U.S. Provisional Patent Application Ser. No. 61/974,486, filed on Apr. 3, 2014 and entitled “Systems and Methods for Protecting Web Sites from Botnet Attacks,” the entire disclosure of which is incorporated herein by reference.

### FIELD OF THE INVENTION

The present invention is directed to methods and systems for protecting a website from a network attack and, more particularly, to preventing unauthorized login attempts by a botnet.

### BACKGROUND

As the Internet becomes increasingly ubiquitous in everyday life, website operators face an increasing number of challenges to the security of their website. Many different security measures and systems exist to protect a website from misuse or hijacking. For example, one of the most common and most effective defenses against security challenges is to require login credentials, such as a username and password, for a website.

Unfortunately, illicit entities are continually devising new ways to bypass or otherwise overcome the login credential requirement in order to misappropriate a website or domain. One type of security challenge is the “botnet” attack, in which a large collection of distributed computers with a connection to the Internet launch a coordinated attack on a website or domain. The word “botnet,” for example, is short for robot network which refers to the automated network of comprised computers from which the attack is launched. A comprised computer, called a “bot,” is created when malware is intentionally or inadvertently installed. Once the malware is installed and activated, the compromised computer can be controlled by the entity that created or directed the malware.

During a botnet attack, the network of compromised computers will typically attempt to successfully navigate the requirement for login credentials by repeatedly trying to log into the website using a common username, such as “admin,” and various password combinations until the correct login information is derived. Even if the botnet attack does not successfully derive the password, the deluge of login attempts will improperly divert resources and negatively impact performance of the website for users. Even worse, the illicit entity may seek to utilize the botnet to launch a Denial-of-Service (DoS) attack by overloading the website to cause interruption.

There are several mechanisms for preventing or resolving botnet attacks, although most are not effective. For example, perhaps the most direct mechanism for preventing a botnet attack is to stop malware from infecting and compromising computers in the first place. Another mechanism for dealing with an attack is to directly detect botnet control traffic and divert or stop that control traffic. A third approach to prevent a botnet attack is to detect botnet attack traffic, and divert or stop that attack traffic. Unfortunately, each of these approaches is almost entirely ineffective. There will always be, for example, numerous computers and networks which are highly susceptible to malware infection. Further, both botnet control and attack traffic can be extremely difficult, if not impossible, to detect.

Accordingly, there is a continued need in the art for effective methods and computer systems that prevent unauthorized login attempts by a botnet.

### SUMMARY OF THE INVENTION

The present invention is directed to inventive Internet-centric methods and systems for protecting a website from a botnet attack. According to embodiments disclosed herein, the protection system includes a processor and a memory having a stored list of blocked IP addresses. When a user or a bot attempts to log into the website, the IP address of the user or bot is received by the processor, which compares that IP address to the stored list of blocked IP addresses. If the IP address is not blocked, the user is allowed to continue the attempt to log into the website. If the IP address is blocked, then the user or bot is prevented from logging into the website. The processor can also update the stored list of blocked IP addresses to include an IP address associated with a bot or user that has exceeded a predetermined number of failed login attempts within a predetermined period of time. An entry on the blocked IP address list may be for only a limited amount of time, which can be dependent on a variety of factors including the number of failed login attempts.

According to an aspect, a protection system for preventing an unauthorized login attempt, where the system is in communication with a plurality of servers in a distributed computing network, each of the servers hosting a website and comprising a security key, includes: a memory with first data representing a plurality of security keys, and further with second data representing a plurality of blacklisted IP addresses; and a processor in communication with the memory and the distributed computing network, where the processor is configured to: (i) receive from one of the plurality of servers a first communication, the communication including a security key and an IP address associated with an entity attempting to login to the website hosted by that server; (ii) compare the received security key to the first data and authenticate the first communication if the received security key matches one of the security keys in the first data; (iii) compare the IP address to the second data and determine whether the IP address is one of the plurality of blacklisted IP addresses; and (iv) provide to the server, based on the comparison of the IP address to the second data, an indication of whether the IP address is one of the plurality of blacklisted IP addresses.

According to an embodiment, the processor is further configured to update the second data to add an IP address to the list of blacklisted IP addresses, if an entity associated with the IP address exceeds a predetermined number of login attempts at one or more of the plurality of servers in an associated predetermined period of time.

According to an embodiment, the processor is further configured to update the second data to remove the added IP address after a predetermined exclusion period has elapsed.

According to an embodiment, the predetermined exclusion period is based on the number of login attempts made within the predetermined period of time by the IP address, the amount of time between each of the login attempts, and/or whether the login attempts are made by the IP address at more than one of the plurality of servers.

According to an embodiment, the memory further includes third data representing a plurality of authorized IP addresses, where the processor is further configured to: compare the IP address to the third data and determine whether the IP address is one of the plurality of authorized IP addresses; and provide to the server, based on the comparison, an indication of whether the IP address is one of the plurality of authorized IP addresses.

According to an embodiment, the processor is further configured to provide to the server, based on the comparison of the security key to the first data, an indication of whether the security key is one of the plurality of security keys.

According to an aspect, a computer-implemented method for preventing an unauthorized login attempt includes the steps of: (i) receiving, at a central server in communication with a plurality of servers in a distributed computing network, each of the servers hosting a website and comprising a security key, a first communication from one of the plurality of servers, the first communication including a security key and an IP address associated with an entity attempting to login to the website hosted by that server; (ii) comparing, by the central server, the received security key to first data stored in memory, the first data representing a plurality of security keys; (iii) authenticating the first communication if the received security key matches one of the security keys in the first data; (iv) comparing, by the central server, the received IP address to second data stored in memory, the second data representing a plurality of blacklisted IP addresses; (v) determining whether the received IP address is one of the plurality of blacklisted IP addresses; and (vi) providing, to the server, an indication of whether the IP address is one of the plurality of blacklisted IP addresses.

According to an embodiment, the method further includes the step of providing to the server, based on the comparison of the communicated security key to the first data, an indication of whether the communicated security key is one of the plurality of security keys.

According to an embodiment, the method further includes the step of updating the second data to add an IP address to the list of blacklisted IP addresses, if communications from one or more of the plurality of servers include that IP address more than a predetermined number of times within a predetermined period of time.

According to an embodiment, the method further includes the step of updating the second data to remove an IP address after a predetermined exclusion period has elapsed.

According to an embodiment, the predetermined exclusion period is based on the number of login attempts made within the predetermined period of time by the IP address, the amount of time between each of the login attempts, and/or whether the login attempts are made by the IP address at more than one of the plurality of servers.

According to an embodiment, the memory further includes third data representing a plurality of authorized IP addresses, and the method further includes the step of: comparing, by the central server, the received IP address to the third data; determining whether the received IP address is one of the plurality of authorized IP addresses; and providing, to the server, an indication of whether the IP address is one of the plurality of authorized IP addresses.

According to an embodiment, the method further includes the step of updating the third data to remove an IP address to the list of authorized IP addresses.

According to as aspect, a computer-implemented method for preventing an unauthorized login attempt includes the steps of: (i) receiving, at a server, a request to login to a website hosted by the server, the request including an IP address associated with an entity attempting to login to the website, wherein the server is one of a plurality of servers in a distributed computing network, each of the plurality of servers in the distributed computing network hosting a website and comprising a unique security key; (ii) sending, to a remote central server with memory storing first data representing a plurality of security keys and second data representing a plurality of blacklisted IP addresses, a first communication including the server's unique security key and the IP address; (iii) receiving, from the central server, an indication of whether the IP address is one of a plurality of blacklisted IP addresses; and (iv) allowing, if the IP address is not one of the plurality of blacklisted IP addresses, the entity to continue with the login, or preventing, if the IP address is one of the plurality of blacklisted IP addresses, the entity from continuing with the login.

According to an embodiment, the method further includes the step of receiving, from the central server, an indication of whether the communicated security key is one of the plurality of security keys.

According to an embodiment, the memory further stores third data representing a plurality of authorized IP addresses, and the method further includes the step of receiving, from the central server, an indication of whether the IP address is one of the plurality of authorized IP addresses.

It should be appreciated that the inventive aspects and embodiments can be implemented and utilized in numerous ways, including without limitation as a process, an apparatus, a system, a device, a method for applications now known and later developed, or a computer readable medium. These and other unique features of the system disclosed herein will become more readily apparent from the following description and the accompanying drawings.

### BRIEF DESCRIPTION OF THE DRAWINGS

The present invention will be more fully understood and appreciated by reading the following Detailed Description in conjunction with the accompanying drawings, in which:

FIG. 1 is a flowchart of a method for preventing unauthorized login attempts by a botnet in accordance with an embodiment.

FIG. 2 is a schematic representation of a system for preventing unauthorized login attempts by a botnet in accordance with an embodiment.

FIG. 3 is a schematic representation of a system for preventing unauthorized login attempts by a botnet in accordance with an embodiment.

FIG. 4 is a flowchart of a method for preventing unauthorized login attempts by a botnet in accordance with an embodiment.

### DETAILED DESCRIPTION OF EMBODIMENTS

The disclosure describes inventive methods and systems for protecting a website from a botnet attack. Various embodiments described or otherwise envisioned herein are directed to a computer system configured to compare the IP address of a user or bot attempting to log into a website to a list of authorized and/or blocked IP addresses, and allow or prevent the login attempt based on the outcome of the comparison. The computer system can update the stored list of IP addresses based on repeated attempts to log into the website.

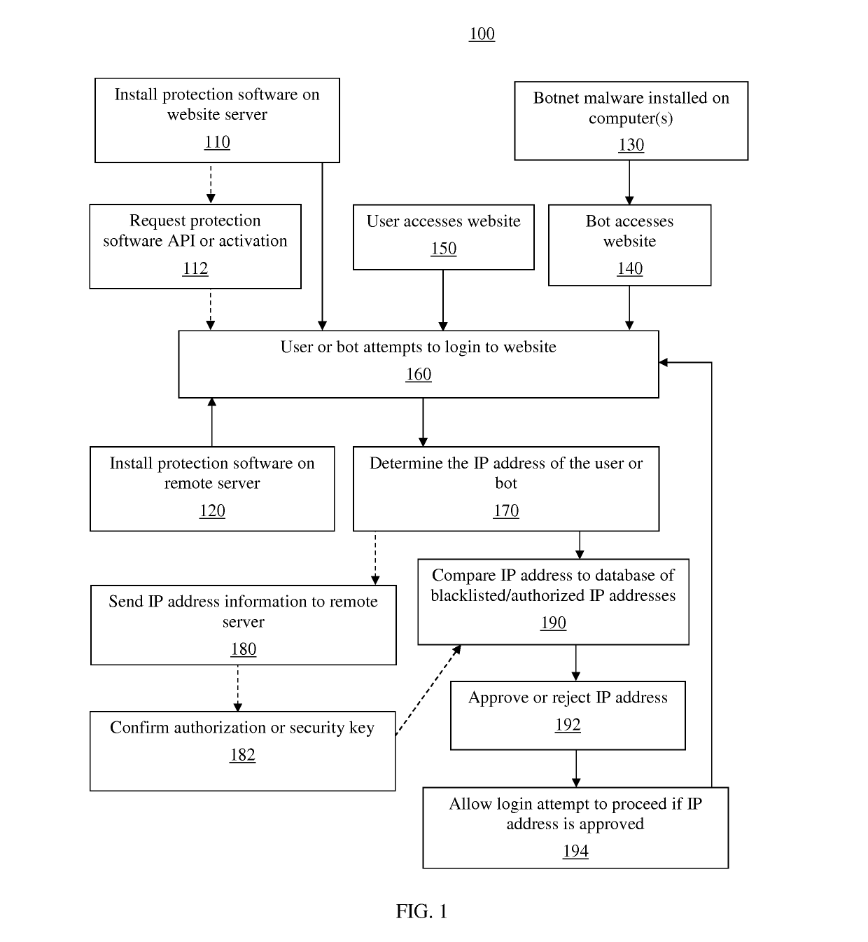

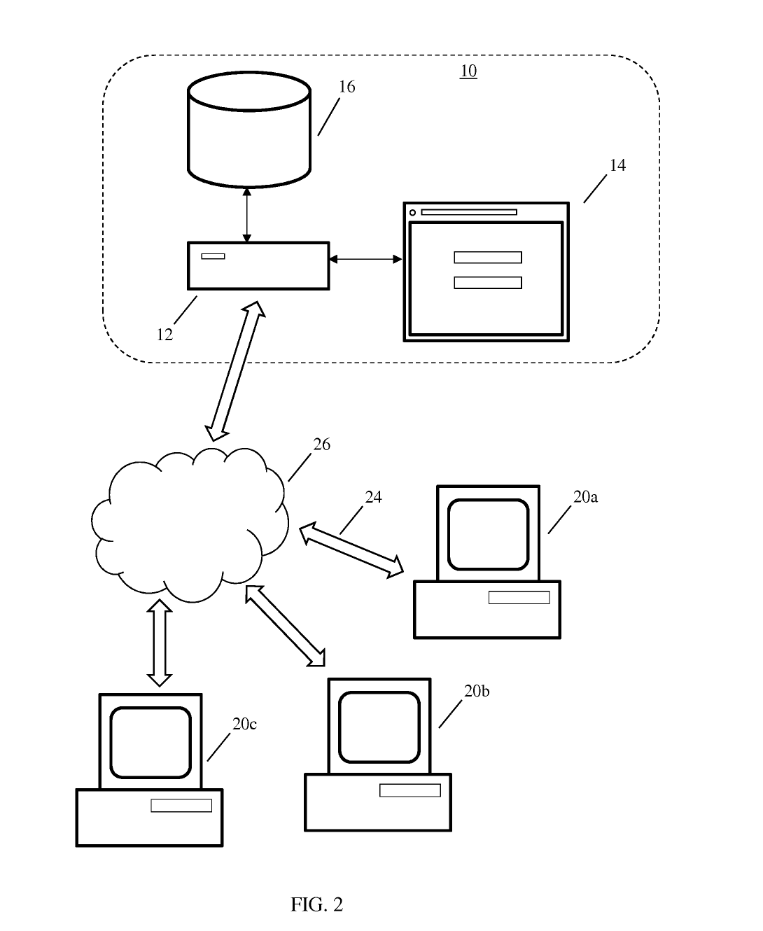

Referring to FIG. 1, in one embodiment, is a flowchart of a method 100 for protecting a website from a botnet attack. In step 110, the protection software is installed on a computer or server 12 which hosts one or more websites 14, as shown in FIG. 2. The server 12 or a different server houses one or more databases 16 necessary for the proper operation of the protection system. The server 12 is any of a number of servers known to those skilled in the art, including but not limited to servers that are intended to be operably connected to a network so as to operably link to a plurality of client computers via a distributed computer network. As illustration, the server 12 typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server may be used for storing data, client applications and the like utilized by client applications. The hard disk drive(s) of the server 12 also are typically provided for purposes of booting and storing the operating system, other applications or systems that are to be executed on the server, with paging and swapping between the hard disk and the RAM.

According to an embodiment, the protection software can be downloaded from the internet, a network, or memory and then installed on the server. Alternatively, the protection software may be available as an add-on for popular systems such as the WordPress®, Drupal™, and Joomla!® content management systems. The protection software could function as a server side solution. Preferably, the protection software is built on a scalable framework such as CodeIgniter®. Step 110 can be completed days, months, or years before the other steps of the method. For example, the protection software may be pre-installed on a server prior to the server being purchased or set-up for website hosting.

According to an embodiment, the protection software must be activated at optional step 112 of the method. In the case of a subscription or license, the protection software is only activated if the installer successfully enters an authorization code such as a license or purchase number. Accordingly, locally-installed protection software may need the ability to communicate with a remote authorization server in order to confirm the submitted authorization code.

Additionally, the protection software can request a security code that it will use in communications to a remote server 22. For example, the protection software could request an application programming interface (“API”) key from the remote server 22 or another computer or server. The protection software will then store the granted API key locally, and will utilize the key to identify itself whenever it communicates with the remote server. The API can also be used by the remote server as an authorization indicator.

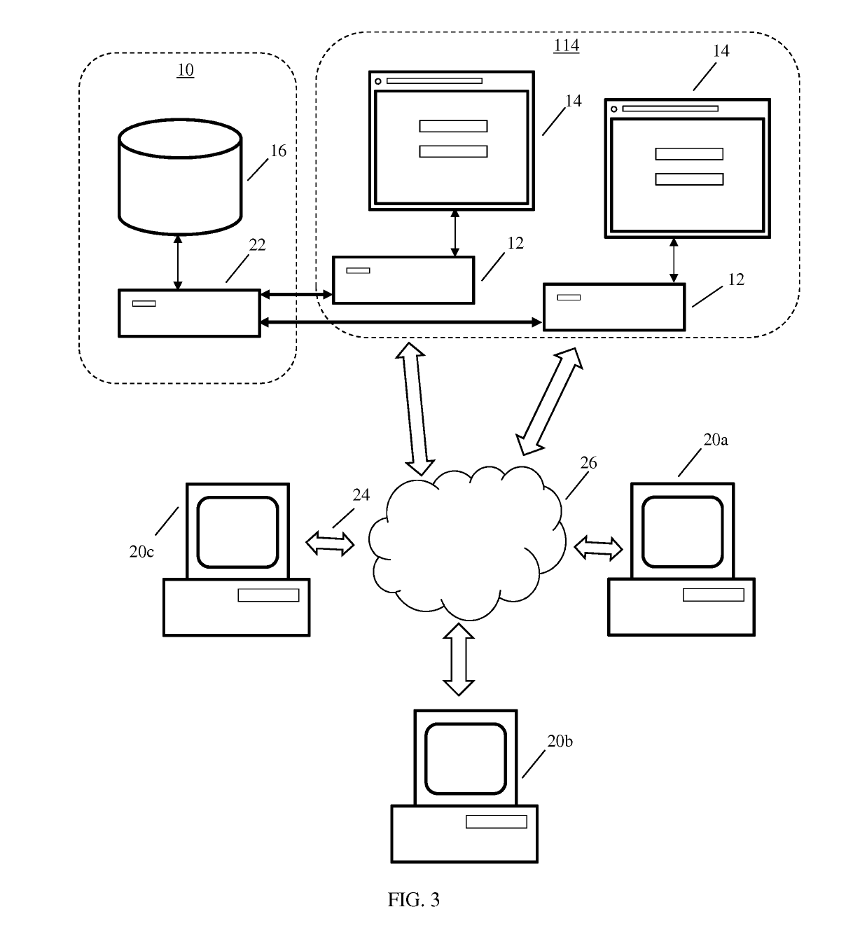

According to an embodiment, at step 120 of the method the protection software is also, or alternatively, installed on a remote server 22, as shown in FIG. 3. The protection software in its entirety may be installed on the remote server 22, or a portion or component of the protection software may be installed on the remote server 22. For example, the software installed on one or more servers 12 may interact with, communicate with, or otherwise function together with or in cooperation with, software installed on remote server 22.

At step 130 of the method, an illicit entity installs malware or other botnet-creating or -directing software on one or more client computers 20 (labeled 20a, 20b, and 20c in FIGS. 2 and 3). The client computers 20 may be desktop computers, laptops, personal digital assistants, cellular telephones, smartphones, handheld devices, and combinations thereof, including anything with a processor and a connection 24 to the computer network 26 that will be used to mount the botnet attack. The computer network 26 can be the Internet, and can also be any number of network systems known to those skilled in the art. For example, the computer network may be a combination of local area networks (LAN), wide area networks (WAN) and the like.

The client computers typically provide users with access to the system 10 and network 114 described below. Thus, some client computers are associated or owned by individual consumers. Other client computers as well as other servers are owned or leased by the company that provides goods and services to the users. It will be recognized by those of ordinary skill in the art that the hardware of the client computers would often be interchangeable. A plurality of users typically can share the same client computer and cookie technology can be utilized to facilitate access to the environment 10. The client computers typically also include a central processing unit including one or more micro-processors such as those manufactured by Intel or AMD, random access memory (RAM), mechanisms and structures for performing I/O operations (not shown), a storage medium such as a magnetic hard disk drive(s), a modem for communicating with the distributed computer network, a device for reading from and/or writing to removable computer readable media and an operating system for execution on the central processing unit. The client computer hard disk drive has a browser for accessing applications hosted within the distributed computing network.

At step 140, the bot accesses the website 14. The bot can be directed to access the website at a random time and/or date based on programming, or can be directed to access the website in response to a command or direction from the illicit entity that caused the malware to be installed on the bot. Alternatively, at step 150 of the method, an authorized user accesses the website 14. In either case, at step 160 of the method the authorized user and/or the bot attempts to login to the website using the login credentials. The user will have pre-existing knowledge of the required login credentials due to memorization, a password manager, or other storage and retrieval mechanism. In contrast, the bot will have no pre-existing knowledge of the required login credentials, and will attempt to login using a random or pre-programmed username and password combination. In many cases, the bot may use a common username such as “admin” and a common password such as “12345” or “password.” If the botnet is particularly organized or structured, the bots may work in a systematic way to avoid duplication of efforts, and will use passwords that are either determined from a database of passwords, such as a database of the most common passwords, or determined by an algorithm designed to select a most likely password based on one or more factors.

At step 170 of the method, the IP address (e.g., 192.24.234.23) of the bot or user is determined by the protection software, and statistics and information related to the IP address are tracked. The IP address and related statistics and information can be determined using any of the methods known in the art.

According to one embodiment, at step 180 of the method depicted in FIG. 1, the IP address obtained from the authorized user, bot, or other entity attempting to log into the website is sent to a remote server 22. For example, the protection software can be programmed or configured to send the IP address and any associated information to the remote server. The communication from the protection software to the remote server 22 can also include a security or API key that serves to identify and/or authenticate the protection server and the communication. At step 182, for example, the remote server or other authentication server can authenticate the security or API key. Following the authentication, the method is allowed to progress to the next step.

At step 190 of the method, the IP address obtained from the authorized user, bot, or other entity attempting to log into the website is compared to a list of IP addresses, which is stored in database 16. According to one embodiment database 16 is a local database, and according to another embodiment database 16 is a component of, or associated with, remote server 22. The database 16 contains an evolving list of blacklisted IP addresses. If the IP address is clear (e.g., not in the Blacklist), approval of the IP address is sent to the website at step 192. Once approval is received at the website 14 or the protection software on server 12, the user is allowed to proceed with the login process at step 194. Provided the user has a valid username and password, the user is then successfully able to attempt to login to the website 14.

According to another embodiment, the IP address may be compared to a whitelist of IP addresses, such as a list of approved IP addresses. For example, employees of the company hosting the website, the owner/operator of the website, and many other authorized users may be listed in the whitelist. If an IP address attempting login is on the whitelist, then the IP address is indicated as such so that login may proceed.

In contrast, if the IP address is not on the whitelist, or if the IP address is on the blacklist, then authorization is not communicated to the website at step 192. Alternatively, that information is communicated to the protection software on server 12, and appropriate steps are taken. For example, the protection software may redirect the user or bot to another website. The protection software may block the user or bot from the website entirely. Several other remedial and/or protective options are available.

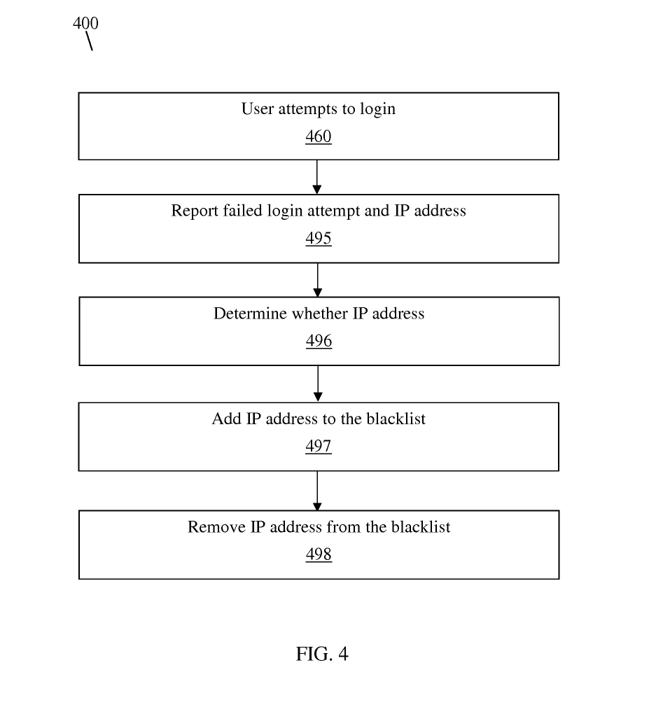

Although the user is authorized to login at step 192, the login attempt may still be unsuccessful. For example, it may be an unauthorized user attempting to gain access by using a Botnet to circumvent the login page. This phenomenon is actually one way in which the blacklist is created, as shown by the method 400 depicted in FIG. 4. When a login by the user is unsuccessful, either once or several times, the associated IP address can be added to the blacklist at step 497. For example, too many failed login attempts in a specified or predetermined time period is a likely indication that the user is an attacker. Hence, at the website, if the user or bot makes a certain number of unsuccessful attempts with a predetermined timeframe, then the IP address associated with the user or bot is added to the blacklist.

According to an embodiment, inclusion on the blacklist may not be permanent. At step 498 of the method 400 in FIG. 4, for example, the IP address is removed or deleted from the black list. For example, inclusion on the blacklist may be for a predetermined time period depending upon a variety of factors, one of which is the extent of the violation. Exemplary timeframes and attempts could include the following:
8 failed attempts in 8 hours results in inclusion in the blacklist for 8 hours;
15 failed attempts in 24 hours results in inclusion in the blacklist for 48 hours;
25 failed attempts in 7 days results in inclusion in the blacklist for 14 days;
40 failed attempts in 1 month results in inclusion in the blacklist for 2 months; and
65 failed attempts in 1 year results in inclusion in the blacklist for 2 years.
   These are just examples of timeframes, attempts, and inclusion periods, and all three of these variables are highly adjustable either individually or together.

The protection software may consider several different factors, or a plurality of factors, to determine whether or not an IP address should be placed on the blacklist. For example, if the login attempts are being received faster than a person could manually enter them, then the IP address is entered on the blacklist Another factor is how the login attempts are being delivered. If the login attempts come in across multiple domains, this is an additional indication of a likely Botnet attack that warrants having the IP address placed on the blacklist Other factors may be the total number of attempts made, the time between attempts, whether both the entered username and password is incorrect, and a variety of other factors.

Alternatively, the protection software may block any and all login attempts if a predetermined number of unsuccessful login attempts are made to a single website within a specific period of time, regardless of whether the login attempts are made by a single entity or all different entities. Numerous unsuccessful attempts within a significantly short period of time is indicative of an attack, and the protection software may be programmed or designed to block all login attempts for maximum security.

Unsuccessful login attempts may be counted against the user from a single website. However, in a preferred embodiment, if a specific IP address exceeds a predetermined number of unsuccessful login attempts on any website with the protection software, the specific IP address will be added to a centralized blacklist so that other websites are protected from the same specific IP address. Accordingly, the protection software offers advantages over other solutions that offer a one-to-one relationship between tracked IP addresses and websites. Unlike these solutions, the protection software tracks the IP addresses of failed login attempts across all websites using the protection software in the environment 10.

According to an embodiment, if a first website has enough failed attempts in a predetermined period of time from a first IP address, then immediately all websites using the protection software can block this first IP address. Not only does this protect all websites from the possibility of a malicious login, but it also helps to prevent a DoS attack. In a distributed DoS attack looking to take down a website by overwhelming it with traffic and requests, the protection software is able to reduce 75% of the server load on the protected website by effectively blocking IP's with only three database requests, rather than the normally required twelve requests.

Referring to FIG. 3 is a network 114 of servers 12 and associated websites 14. According to an embodiment, the protection software running in environment 10 and on servers 12 connects all websites 14 to create a network 114 of servers 12 and associated websites 14. Once the websites 14 are connected in the environment 10, the blacklist is shared across the environment 10, including for example in a closed manner through the API. According to one embodiment, the websites and website administrators have no direct access to the blacklist, and instead comparisons are made against the blacklist in real-time using a simple algorithmic check. In an alternative embodiment, the blacklist is provided to companies hosting the websites or otherwise and periodically updated.

According to one embodiment of the method, an IP address is blocked across a network of websites running the protection software by the following mechanism, as described above in reference to FIG. 1. At step 170, the IP address (e.g., 192.24.234.23) of the bot or user is determined by the protection software. The IP address 192.24.234.23 is sent to the server 22 at step 180, and the server 22 checks the IP address 192.24.234.23 against the blacklist in the associated database 16 at step 190. It is determined that the IP address is not on the blacklist, and at step 194, the user associated with IP address 192.24.234.23 is allowed to continue logging in. In other words, the server 22 sends data to the website to allow this user access to the login page.

As shown in FIG. 4, the protection software also reports failed login attempts to remote server 22. At step 460 of the method 400 in FIG. 4, the user attempts to login to the website but the login attempt fails. Failure to login to the website could be due to an authorized user forgetting login credentials or mistyping login credentials, for example. Failure to login to the website could also be due to an attacker not knowing the actual login credentials. At step 495, after a failed login attempt, the IP address associated with the failed login attempt is reported to server 22. At step 496, the remote server 22 determines whether the IP address associated with the failed login attempt should be added to the IP blacklist. This determination could be based on a variety of factors, including the number of failed login attempts within a certain time period either at this website alone or in combination with the plurality of websites utilizing the protection software. For example, after numerous failed login attempts on one of any of the websites 14 in the network 114 within a predetermined period of time, the system determines that the IP address 192.24.234.23 should be logged as a malicious IP address in the blacklist, and at step 497 of the method, the IP address is added to the IP blacklist. For all future login attempts during the predetermined banned period, login attempts associated with IP address 192.24.234.23 are blocked from access to any and all websites within the network 114. Accordingly, the method creates a blacklist of IP addresses that are not allowed to attempt logging in to any websites subscribed to or running the protection software. As discussed above, the IP address may be permanently or temporarily added to the blacklist depending upon a wide variety of factors and considerations. According to an embodiment, the IP address is maintained on the blacklist for a predetermined time period, and at step 498 of the method the IP address is removed from the blacklist following expiration of the time period. This temporary inclusion prevents users who are potentially valid but have been the subject of a botnet infection from being permanently prevented from logging into the website in the future.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present invention has been described in connection with a preferred embodiment, it should be understood that modifications, alterations, and additions can be made to the invention without departing from the scope of the invention as defined by the claims.

What is claimed is:

1. A protection system for preventing an unauthorized login attempt, wherein the system is in communication with a plurality of servers in a distributed computing network, each of the servers hosting a website and comprising a security key, the system comprising:
a memory comprising first data representing a plurality of security keys, and further comprising second data representing a plurality of blacklisted IP addresses; and
a processor in communication with the memory and the distributed computing network, wherein the processor is configured to:
(i) receive from one of the plurality of servers a first communication, the communication comprising a security key and an IP address associated with an entity attempting to login to the website hosted by that server;
(ii) compare the received security key to the first data and authenticate the first communication if the received security key matches one of the security keys in the first data;
(iii) compare the IP address to the second data and determine whether the IP address is one of the plurality of blacklisted IP addresses; and
(iv) provide to the server, based on the comparison of the IP address to the second data, an indication of whether the IP address is one of the plurality of blacklisted IP addresses.

2. The protection system of claim 1, wherein the processor is further configured to update the second data to add an IP address to the list of blacklisted IP addresses, if an entity associated with the IP address exceeds a predetermined number of login attempts at one or more of the plurality of servers in an associated predetermined period of time.

3. The system of claim 2, wherein the processor is further configured to update the second data to remove the added IP address after a predetermined exclusion period has elapsed.

4. The system of claim 3, wherein the predetermined exclusion period is based on the number of login attempts made within the predetermined period of time by the IP address.

5. The system of claim 3, wherein the predetermined exclusion period is based on whether the login attempts are made by the IP address at more than one of the plurality of servers.

6. The system of claim 1, wherein the memory comprises third data representing a plurality of authorized IP addresses, and wherein the processor is further configured to:
compare the IP address to the third data and determine whether the IP address is one of the plurality of authorized IP addresses; and
provide to the server, based on the comparison, an indication of whether the IP address is one of the plurality of authorized IP addresses.

7. The system of claim 1, wherein the processor is further configured to provide to the server, based on the comparison of the security key to the first data, an indication of whether the security key is one of the plurality of security keys.

8. A computer-implemented method for preventing an unauthorized login attempt, the method comprising the steps of:
receiving, at a central server in communication with a plurality of servers in a distributed computing network, each of the servers hosting a website and comprising a security key, a first communication from one of the plurality of servers, the first communication comprising a security key and an IP address associated with an entity attempting to login to the website hosted by that server;
comparing, by the central server, the received security key to first data stored in memory, the first data representing a plurality of security keys;
authenticating the first communication if the received security key matches one of the security keys in the first data;
comparing, by the central server, the received IP address to second data stored in memory, the second data representing a plurality of blacklisted IP addresses;
determining whether the received IP address is one of the plurality of blacklisted IP addresses; and
providing, to the server, an indication of whether the IP address is one of the plurality of blacklisted IP addresses.

9. The method of claim 8, further comprising the step of providing to the server, based on the comparison of the communicated security key to the first data, an indication of whether the communicated security key is one of the plurality of security keys.

10. The method of claim 8, further comprising the step of updating the second data to add an IP address to the list of blacklisted IP addresses, if communications from one or more of the plurality of servers comprise that IP address more than a predetermined number of times within a predetermined period of time.

11. The method of claim 8, further comprising the step of updating the second data to remove an IP address after a predetermined exclusion period has elapsed.

12. The method of claim 11, wherein the predetermined exclusion period is based on the number of login attempts made within the predetermined period of time by the IP address.

13. The method of claim 11, wherein the predetermined exclusion period is based on whether the login attempts are made by the IP address at more than one of the plurality of servers.

14. The method of claim 8, wherein the memory comprises third data representing a plurality of authorized IP addresses, and further comprising the steps of:
comparing, by the central server, the received IP address to the third data;
determining whether the received IP address is one of the plurality of authorized IP addresses; and
providing, to the server, an indication of whether the IP address is one of the plurality of authorized IP addresses.

15. The method of claim 14, further comprising the step of updating the third data to remove an IP address to the list of authorized IP addresses.
